(19) United States
(12) Patent Application Publication
(10) Pub. No.: US 2019/0294740 A1
(43) Pub. Date: Sep. 26, 2019

(54) FORECASTING APPARATUS, PARAMETER SET GENERATING METHOD, AND PROGRAM

(71) Applicant: NATIONAL UNIVERSITY CORPORATION KUMAMOTO UNIVERSITY, Kumamoto-shi, Kumamoto (JP)

(72) Inventors: Yasuko MATSUBARA, Kumamoto-shi, Kumamoto (JP); Yasushi SAKURAI, Kumamoto-shi, Kumamoto (JP)

(21) Appl. No.: 16/316,946

(22) PCT Filed: Jul. 11, 2017
(86) PCT No.: PCT/JP2017/025236

§ 371 Date: Jan. 10, 2019

(30) Foreign Application Priority Data
Jul. 12, 2016 (JP) 2016-138075

(51) Int. Cl. G06F 17/50

(52) U.S. Cl. CPC G06F 17/5009; G06F 2217/16

(57) ABSTRACT

A forecasting apparatus or the like is proposed, which provides high-precision long-term forecasting using a large-scale time-series data stream. The forecasting apparatus includes a current window calculation unit, a regime updating unit, and a regime inserting unit, in order to handle a nested multi-level data stream structure. A mathematical model identified by a parameter set stored in a parameter set storage unit includes a non-linear component, which allows a non-linear pattern of the data stream to be represented. The regime updating unit updates the parameter set so as to provide forecasting based on a non-linear dynamical system. Furthermore, the regime inserting unit inserts a new pattern (regime) for the data stream. The regime updating unit uses a regime shift, which is a transition from a regime to another regime that occurs in the event stream. This provides high-precision long-term forecasting.

### TECHNICAL FIELD

The present invention relates to a forecasting apparatus, a parameter set generating method, and a program, and particularly, to a forecasting apparatus, etc., configured to forecast one or multiple lₛ-step-ahead or greater future event values V_{E} from a time tick t_{c} using a current window X_{c} which is part of a data stream X acquired up to the time tick t_{c}.

### BACKGROUND ART

The present inventors have researched time-series data analysis (see Non-patent document 1). The AutoPlait algorithm proposed by the present inventors has been attracting attention as a method for extracting the characteristics of time-series data.

Examples of known forecasting models based on time-series data include: the AR model (autoregressive model); the ARIMA (autoregressive integrated moving average model) which is an improved model of the AR model; LDS (linear dynamical systems); KF (Kalman filters); and the like. As an analysis and forecasting method for time-series data based on the aforementioned forecasting models, AWSOM, TBATS, PLiF, and the like have been proposed.

### CITATION LIST

### Non-Patent Literature

### [Non-Patent Document]

Y. Matsubara, one other person, Christos Faloutsos: “AutoPlait: Automatic Mining of Co-evolving Time Sequences”, ACM SIGMOD Conference, pp. 193-204, Snowbird, Utah, June 2014.

### SUMMARY OF INVENTION

### Technical Problem

However, conventionally, in almost all cases, such a method employs a linear system, leading to a problem of insufficient performance for modeling the characteristics of non-linear time-series data. Even in a case in which such a conventional method employs a non-linear system, a modeling method based on a nearest neighbor search has been the mainstream. Such a modeling method has no capability of modeling time-series data over a long term.

Accordingly, it is a purpose of the present invention to propose a forecasting apparatus or the like that is capable of providing high-precision long-term precision based on a large-scale time-series data stream.

### Solution of Problem

A first aspect of the present invention relates to a forecasting apparatus configured to forecast one or multiple lₛ-step-ahead or greater future event values from a time tick t_{c} using a current window X_{c} which is a part of a time-series data X acquired up to the time tick t_{c}. The forecasting apparatus comprises: a parameter set storage unit; a regime updating unit; and a forecasting unit. The parameter set storage unit stores a parameter set that identifies a mathematical model. The mathematical model includes a non-linear component. The parameter set includes a non-linear parameter that identifies a coefficient of the non-linear component. The regime updating unit updates a part or otherwise all of the parameters included in the parameter set except for the non-linear parameter so as to reduce a difference between data of the current window X_{c} at each time tick and an event value V_{C} that corresponds to the current window X_{c} at the corresponding time tick obtained by calculation using a mathematical model identified by the updated parameter set. The forecasting unit forecasts one or multiple lₛ-step-ahead or greater future event values from the time tick t_{c} using the mathematical model identified by the updated parameter set.

A second aspect of the present invention relates to the forecasting apparatus according to the first aspect. The parameter set storage unit stores c (c represents an integer) parameter sets θᵢ (i=1, . . . , c). The forecasting unit forecasts an event value V_{E} using a part of or otherwise all of the updated c parameter sets θᵢ.

A third aspect of the present invention relates to the forecasting apparatus according to the second aspect. The forecasting apparatus further comprises a regime inserting unit. The regime inserting unit is configured such that, when the difference between the data of the current window X_{c} at each time tick and the event value V_{C} at the corresponding time tick obtained using the updated c parameter sets θᵢ satisfies an inserting condition, the regime inserting unit inserts a new parameter set θ_{c+1} in the parameter set storage unit. The regime updating unit updates a part of or otherwise all of the parameters included in the (c+1) parameter sets θᵢ (i=1, . . . , c+1) except for the non-linear parameter. The forecasting unit forecasts an event value using a part of or otherwise all of the mathematical models identified by the updated (c+1) parameter sets θᵢ (i=1, . . . , c+1).

A fourth aspect of the present invention relates to the forecasting apparatus according to any one of the first aspect through the third aspect. The mathematical model includes a linear component. The parameter set includes a linear parameter that identifies the linear component. The regime inserting unit determines the linear parameter without changing the non-linear parameter. The regime inserting unit determines the non-linear parameter using the linear parameter thus determined.

A fifth aspect of the present invention relates to the forecasting apparatus according to any one of the first aspect through the fourth aspect. The current window X_{C}^{(j)} (j=1, . . . , h, h represents an integer) is configured to have a nested h-level structure. The parameter set is configured to have a nested h-level structure corresponding to the current window X_{C}^{(j)} having the nested h-level structure. The regime updating unit updates the parameter set for each level. The forecasting unit forecasts an overall event value based on the event values forecasted for respective levels.

A sixth aspect of the present invention relates to a parameter set generating method for generating a new parameter set by changing a part of a parameter set that identifies a mathematical model using a current window X_{c} which is a part of time-series data acquired up to a time tick t_{c}. The mathematical model includes a non-linear component. The parameter set includes a non-linear parameter that identifies the non-linear component. The parameter set generating method comprises updating in which a regime updating unit included in an information processing apparatus updates a part of or otherwise all of parameters included in the parameter set without changing the non-linear parameter so as to reduce a difference between data of the current window X_{c} at each time tick and an event value V_{C} that corresponds to the current window X_{c} at the corresponding time tick calculated based on a mathematical model identified by the parameter set thus updated.

A seventh aspect of the present invention relates to a program configured to instruct a computer to function as the forecasting apparatus according to any one of the first aspect through the fifth aspect.

It should be noted that the present invention may be realized as a computer-readable recording medium configured to constantly record the program according to the seventh aspect of the present invention.

### Advantageous Effects of Invention

The present inventors have focused their attention on the regime concept. A regime represents a characteristic time-evolving pattern in a natural phenomenon in environmental ecology. A regime shift represents a phenomenon in which a regime (time-series pattern) changes to another regime. In recent years, regime shift has been actively studied in various kinds of fields, and particularly, in the environmental ecology field.

The present inventors have extended the regime shift concept in a dynamical system in the natural world so as to propose a novel time-series pattern forecasting method. Similar to such a dynamical system in the natural world, a data stream in the real world evolves over time depending on various kinds of latent factors.

With each aspect of the present invention, when a large-scale time-series data stream is supplied, the latent pattern thereof is represented by a mathematical model including a non-linear component. Furthermore, parameters (e.g., the initial value or the like) are changed except for the non-linear pattern, so as to adjust the mathematical model in an adaptive manner using a non-linear dynamical system while maintaining representation of the latent pattern due to the non-linear component. This arrangement is capable of providing high-precision forecasting based on a data stream in the real world.

Furthermore, with the second aspect of the present invention, multiple non-linear models are employed based on the regime shift concept, so as to capture a regime shift that occurs in the time-series data stream. This arrangement is capable of representing the time-series pattern even if it varies in a complex fashion, thereby providing high-precision forecasting.

Furthermore, with the third aspect of the present invention, this arrangement is capable of automatically capturing a new regime accompanying a regime shift, and of inserting the new regime thus detected as a new time-series pattern.

Furthermore, with the fourth aspect of the present invention, by identifying a non-linear component after a linear component is identified, this arrangement is capable of estimating a model that represents the new regime with high accuracy while suppressing the calculation cost.

An actual time-series data stream is composed of a multi-level dynamical system based on different time evolution. Accordingly, such an actual time-series data stream has a complex time-series pattern, i.e., has a nested multi-level structure. With the fifth aspect of the present invention, by providing forecasting based on a nested multi-level structure, this arrangement provides high-precision forecasting.

### BRIEF DESCRIPTION OF DRAWINGS

FIG. 1 shows the concept of a typical regime shift ((a)), and an example of the concept of the regime shift according to the present invention ((b)).

FIG. 2 shows a snapshot of analysis and forecasting at the current time tick t_{c} according to an embodiment of the present invention.

FIG. 3 shows three algorithms of the RegimeCast according to an embodiment of the present invention.

FIG. 4 is a block diagram showing a schematic configuration of a forecasting apparatus 1 according to an embodiment of the present invention.

FIG. 5 is a flowchart showing an example of the operation of the forecasting apparatus 1 shown in FIG. 4.

FIG. 6 shows an example of data generated by the forecasting apparatus 1 shown in FIG. 4.

FIG. 7 shows an example of RegimeCast analysis results for a motion stream of physical exercise.

FIG. 8 is an example of RegimeCast analysis results for a chicken-dance stream.

FIG. 9 shows forecasting results for three-month-ahead future search volume for each keyword in Google.

FIG. 10 shows forecasting accuracy provided by the present invention and conventional techniques.

FIG. 11 shows the calculation costs required for the proposed method and conventional methods, and shows the forecasting accuracy and the calculation costs for long-term event forecasting.

### DESCRIPTION OF EMBODIMENTS

Description will be made below regarding embodiments of the present invention with reference to the drawings. It should be noted that the present invention is by no means intended to be restricted to such embodiments.

### EMBODIMENTS

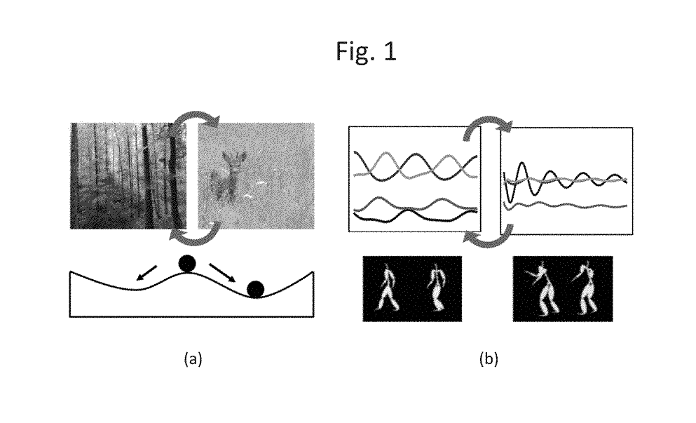

First, description will be made with reference to FIG. 1 regarding the concept of regime shifts. A regime represents a characteristic time-series pattern that occurs in a natural phenomenon in environmental ecology. A regime shift represents a phenomenon in which a given regime changes to a different regime.

A regime shift occurs mainly due to internal factors (variation of stability in a system, etc.) and/or external factors (external shocks applied to the system, etc.). For example, as shown in FIG. 1A, in some cases, a grassland changes to a woodland. For example, in such a grassland, the growth of trees is suppressed due to various kinds of factors such as the existence of herbivores, fires, deforestation, etc., which maintains the grassland as a stable system. However, once trees have grown to a predetermined level or more, this lowers the potential to be affected by the existence of herbivores, fires, or the like, leading to change to a woodland. Similarly, in some cases, a regime shift occurs from a woodland to a grassland.

The present inventors have extended the concept of regime shift in a dynamical system in nature, and have proposed a novel time-series forecasting method. As with a motion data stream shown in FIG. 1B, by employing a time-series pattern in a time-series data stream as a regime, and by using a regime shift in an event stream, this method provides improved forecasting accuracy. In particular, time-series data is represented as an adaptive non-linear dynamical system, which allows a complex time-series pattern to be modeled in a flexible manner. By employing such an adaptive non-linear dynamical system, this arrangement provides improved forecasting accuracy.

With the present invention, when a large-scale data stream composed of various kinds of time-series patterns (e.g., sensor data, Web access history, etc.) is supplied, such an arrangement is capable of capturing important features or latent trends, which provides future time-series data forecasting in a continuous manner for a long period.

First, description will be made regarding an example of a mathematical model employed in forecasting.

The time evolution of each element in an ecosystem is represented by the ordinary differential equation in the following Expression 1. Here, “s(t)” represents a property (nutrients, soils, or the like) of the ecosystem at a given time tick t. “a₀” represents an environmental factor that changes s(t) such as nutrient loading or the like. “a₁” represents the rate at which s(t) grows or decays in the system (e.g., “a₁” represents the nutrient removal rate, for a₁<0). “a₂” represents the rate at which s(t) recovers again as a function f(s(t)) (e.g., internal nutrient recycling). The function “f” causes a regime shift.

$$\frac{ds ( t )}{dt} = {a}_{0} + {a}_{1} s ( t ) + {a}_{2} f ( s ( t ) ) \qquad [ Expression 1 ]$$

The present inventors have extended the concept of regime shift in the dynamical system represented by Expression 1. First, as the simplest pattern representation method, description will be made regarding a representation method for a single dynamical pattern (regime). In this example, there is no regime shift in the event sequence. This model is composed of two kinds of time-evolving activity patterns, i.e., s(t) and v(t). Here, “s(t)” represents a k-dimensional latent value (latent time-evolving pattern). “v(t)” represents a d-dimensional estimated event at the time tick t (actual event measurement value)(e.g., measurement values generated by d multiple sensors). The single regime is represented by Expression 2.

s(t): potential value, i.e., k-dimensional latent activity value at the time tick t (s(t)=sᵢ(t)^{k}ᵢ₌₁)

v(t): estimated event, i.e., d-dimensional measurement value at the time tick t (v(t)=vᵢ(t)^{d}ᵢ₌₁)

As the initial condition, s(0)=s₀ is employed. Furthermore, the derivative of s(t) with respect to the time tick t is represented by ds(t)/dt. Furthermore, the quadratic form matrix of s(t) will be represented by S(t) (i.e., S(t)=s(t)^{T}s(t)). Moreover, “p”, “Q”, and “A” represent a parameter set used to generate the potential value s(t), and are used to represent a linear dynamical pattern, an exponential dynamical pattern, and a non-linear dynamical pattern, respectively (it should be noted that, in this example, the non-linear pattern component A is represented by a quadratic function). “u” and “V” each represent a projection that generates the estimated event v(t) based on the potential value s(t) at the time tick t. As an important condition, the non-linear tensor A is required to be sparse in order to eliminate the complexity of the dynamical system.

The parameter set in the single latent non-linear dynamical system is represented by θ={s₀, p, Q, A, u, V}.

$$\frac{d ( t )}{dt} = + ℚ ( t ) + 𝕊 ( t ) \\ ( t ) = + 𝕍 ( t ) \qquad [ Expression 2 ]$$

Next, description will be made regarding a regime shift that occurs in an event stream. For example, as shown in FIG. 1B, two kinds of regimes (c=2) (walking, wiping) are alternately switched at desired timings. A time-evolving model having improved adaptivity is required to represent such a complex event. In order to solve such a problem, i.e., in order to represent more complex time-evolving pattern, w(t) is introduced. Here, “w(t)” represents the magnitude of the i-th regimes (i=1, . . . , c) in a regime shift at the time tick t.

w(t): regime activity value, i.e., regime magnitudes of c regimes in a regime shift at the time tick t.

The model represented by Expression 2 is extended so as to propose a model represented by Expression 3. Here, “sᵢ(t)” represents a latent value of the i-th regime at the time tick t (Sᵢ(t)={sᵢⱼ((t))^{k}ⱼ₌₁). “w(t)” represents the magnitudes of the i-th regimes at the time tick t (w(t)={wᵢ (t)}^{c}ᵢ₌₁) Here, “v(t)” represents the d-dimensional estimated event at the time tick t. “dw(t)/dt” represents the derivative of w(t) with respect to the time tick t.

In Expression 3, as a new parameter, r(t) is introduced. “r(t)” is represented as a c-dimensional vector at the time tick t. “R” is defined as a parameter set that represents the regime shift dynamics (R(t)={r(t)}^{tc}ᵢ₌₁). Here, “t_{c}” represents the length of the event stream. “R” will be referred to as a regime shift matrix. In a case in which c=1 (in a case in which the event stream is composed of a single regime), the model represented by Expression 3 matches the model represented by Expression 2.

The parameter set for representing the regimes is defined as Θ={θ₁, . . . , θ_{c}, R}. Here, “c” represents the number of regimes included in the event stream.

$$\frac{{d}_{i} ( t )}{dt} = {}_{i} + {ℚ}_{i} {}_{i} ( t ) + {i}_{} {𝕊}_{i} ( t ) \\ \frac{d ( t )}{dt} = ( t ) \\ ( t ) = {\sum }_{i - 1}^{c} {w}_{i} ( t ) [ {}_{i} + {𝕍}_{i} {}_{i} ( t ) ] \qquad [ Expression 3 ]$$

Furthermore, description will be made regarding an extended model, i.e., a multi-level structure model. The systems represented by Expressions 2 and 3 each represent a single-level dynamical system. However, a time-series event in the real world includes various levels of time-series activity patterns based on different time evolution. For example, an event on the Web can include a 10-year cyclic pattern, a daily cyclic pattern, etc. In order to represent such a time-series pattern having a multi-level structure, a model based on a multi-level structure is employed. Specifically, a multi-level regime set M={Θ⁽¹⁾, Θ⁽²⁾, . . . } is employed. The regime set is a full model parameter set for representing a time-series pattern having a multi-level structure. In each i-th level, a corresponding local estimated event v⁽ⁱ⁾(t) is generated. The local estimated events V⁽ⁱ⁾(t) thus generated are superimposed so as to represent the actual estimated event v(t).

Next, description will be made regarding the required concept. Table 1 shows the main symbols and definitions.

TABLE 1

| SYMBOL | DEFINITION |
|---|---|
| d | NUMBER OF DIMENSIONS |
| tᵤ | CURRENT TIME TICK |
| X | d-DIMENSIONAL EVENT STREAM: |
| | X = {x(1), . . . , x(t_{c})} |
| x(t) | d-DIMENSIONAL EVENT AT TIME TICK t: |
| | x(t) = {xᵢ(t)}ᵢ₋₁^{d} |
| s(t) | POTENTIAL VALUE AT TIME TICK t: |
| | s(t) = {sᵢ(t)}ᵢ₌₁^{k} |
| w(t) | REGIME ACTIVITY VALUE AT TIME TICK t: |
| | w(t) = {wᵢ(t)}ᵢ₌₁^{o} |
| x(t) | ESTIMATED EVENT AT TIME TICK t: |
| | v(t) = {vᵢ(t)}ᵢ₌₁^{d} |
| X_{c} | CURRENT WINDOW: X_{c} = X[tₘ:t_{c}] |
| V_{F} | FORECAST WINDOW: V_{F} = V[tₛ:t_{c}] |
| c^{ω} | NUMBER OF REGIMES IN i-TH LEVEL |
| θⱼ^{ω} | PARAMETER SET OF REGIME j IN i-TH LEVEL |
| R^{ω} | REGIME SHIFT MATRIX IN i-TH LEVEL |
| Θ^{ω} | FULL PARAMETER SET IN i-TH LEVEL |
| [symbol] | FULL PARAMETER SET: [symbol] = {Θ(t)}ᵢ₌₁^{h} |

“X” represents a data stream X={x(1), . . . , x(t_{c})} composed of d-dimensional event entries. Here, t_{c} represents the current time tick. The data stream X is referred to as the “event stream”.

Description will be made assuming that a new event entry x(t_{c}) occurs at every time tick. Here, t_{c} is incremented with every advance in time. In this case, the event set that occurs at the latest time tick is defined as a current window as follows. That is to say, the current window is defined to have a partial sequence X_{c}=X[tₘ; t_{c}] having a length l_{c}. Here, X_{c} represents a partial sequence of the event stream X in a range from the time tick tₘ to t_{c} (1≤tₘ≤t_{c}). Description will be made below regarding an example in which l_{c}=3•l_{S}.

After the current window X_{c} is supplied, the next goal is to capture the optimal regime in the parameter set M, and to estimate the lₛ-step-ahead future event V_{F}={v(tₛ), . . . , v(t_{c})} based on the model represented by Expression 3. “V_{F}=V[tₛ, t_{c}]” represents the lₛ-step-ahead future event sequence (t_{c}≤tₛ≤tₑ) with tₛ=t_{c}+lₛ, and with tₑ=tₛ+lₚ. Here, “lₚ” represents the length of the output unit time.

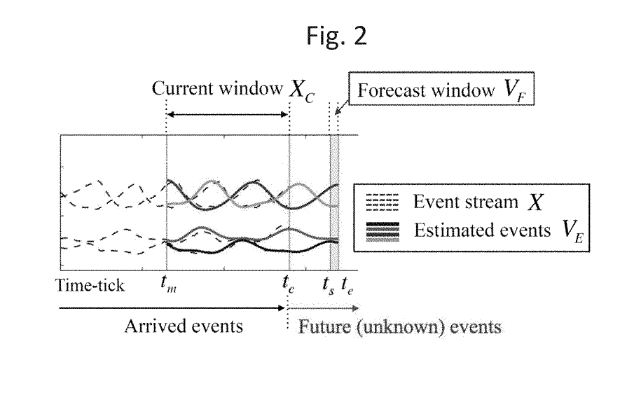

FIG. 2 is a snapshot of RegimeCast at the current time tick t_{c} according to an embodiment of the present invention. Here, the black dotted line represents the original event stream X. In FIG. 2, the event stream X is configured as a d=4 dimensional event sequence. The bold line represents the event estimated value V_{E} in a time range from the time tick tₘ up to the time tick t_{c} generated by RegimeCast. Here, the partial sequence from the time tick t_{c} up to the time tick tₑ represents a future (i.e., unknown) event set. The present invention is required to continuously estimate time-series patterns at high speed. With the present invention, when the original stream X (black dotted line) is supplied, by capturing the latest time-series patterns included in the current window X_{c}, and by representing the time-series patterns thus captured as an adaptive non-linear dynamical system, such an arrangement estimates the current-time time-series pattern V_{E} (colored bold line), and continuously outputs the lₛ-step-ahead future events V_{F} (surrounded by a rectangle) with high speed.

The aforementioned description can be summarized as follows. That is to say, upon receiving the event stream X={x(1), . . . , x(t_{c})}, this arrangement continuously outputs the lₛ-step-ahead future event V_{F}. Specifically, this arrangement detects the optimal regime pattern included in the current window X_{c} at each time tick t_{c}, updates the model parameter set M based on the regime pattern of X_{c} thus detected, and outputs the lₛ-step-ahead future event V_{F}.

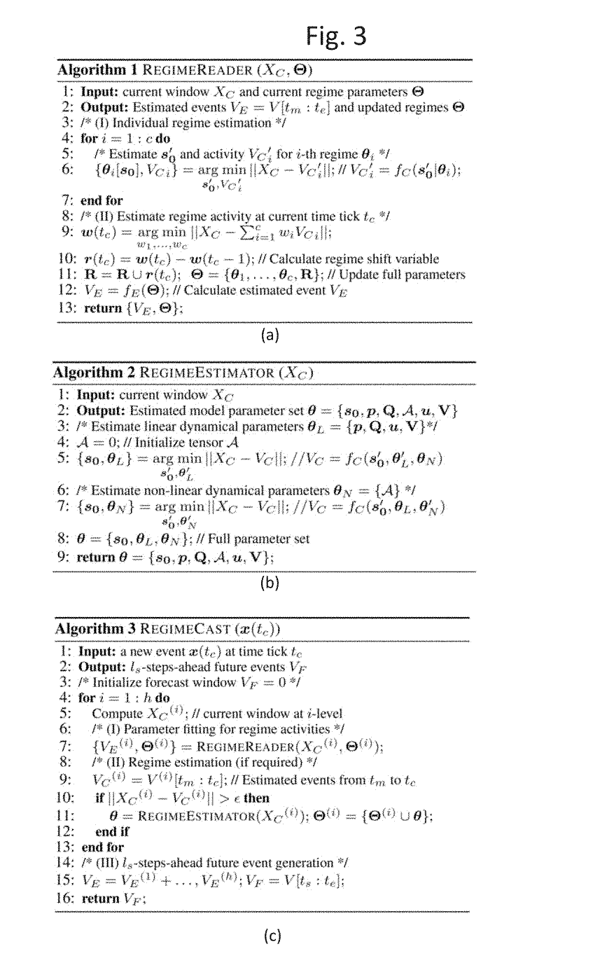

Description will be made with reference to FIG. 3 regarding the outline of RegimeCast, which is an embodiment of the present invention. RegimeCast is composed of the following three algorithms.

RegimeReader: Upon receiving the current window X_{c} and the regime parameter set Θ, RegimeReader estimates the regime dynamics, and generates the event V_{E}=V[tₘ: tₑ] (see FIG. 3A).

RegimeEstimator: When a new regime pattern is included in the current window X_{c}, RegimeEstimator estimates a new parameter set θ that represents the current window X_{c} (see FIG. 3B).

RegimeCast: RegimeCast estimates the optimal event set V_{E}⁽ⁱ⁾ for each level i (i=1, . . . , h), and calculates the estimated event V_{E}=V_{E}⁽¹⁾+V_{E}⁽²⁾+ . . . . Subsequently, RegimeCast reports the lₛ-step-ahead future event (i.e. V_{F}). Furthermore, RegimeCast updates the regime parameter set M (see FIG. 3C).

Detailed description will be made regarding an algorithm shown in FIG. 3. For simplicity of explanation, first, description will be made focusing on only a single-level structure (i.e., h=1). In this case, a single current window X_{c} and a regime parameter set Θ are supplied.

Let us consider a case in which the current window X_{c} and the regime parameter set Θ={θ₁, . . . , θ_{c}, R} are supplied at a time tick t_{c}. The goal of RegimeReader is to estimate the event sequence V_{E}=V[tₘ: tₑ] based on the current regime parameter set Θ.

The most straightforward solution for estimating an appropriate estimated event value is to use a fixed parameter set included in the regime parameter set Θ to calculate v(tₘ), V(tₘ₊₁), . . . , based on the model represented by Expression 3. However, in real event streams, the latent trends in the current window X_{c} dynamically and continuously change over time. Accordingly, the regime parameters included in the regime parameter set Θ are optimized based on the pattern of the latent current window X_{c}. Specifically, the algorithm shown in FIG. 3 is required to flexibly update the parameter set included in the regime parameter set Θ based on the activity patterns at the current time tick included in the current window X.

FIG. 3A shows the flow of the operation of RegimeReader. RegimeReader is composed of two components, i.e., (1) individual regime optimization, and (2) regime shift identification.

(1) Individual Regime Optimization

For each i-th regime parameter θᵢ∈Θ(i=1, . . . , c), the initial value of the potential value s₀∈θᵢ is optimized. Specifically, the initial value of the potential value so is optimized so as to minimize the mean square error between the original event and the estimated event (i.e., min∥X_{c}−X_{ci}∥). Here, the function f_{c}(s₀|θ) represents the estimated event V_{c}={v(tₘ), . . . , v(t_{c})} calculated based on the model represented by Expression 3 assuming that the regime parameters s₀ and θ are supplied.

(2) Regime Shift Identification

RegimeReader estimates the latent dynamical pattern of the regime shift at the time tick t_{c} based on the c multiple estimated events {V_{ci}}^{c}ᵢ₌₁ obtained in (1). Specifically, in order to optimize the regime set included in the regime parameter set Θ, RegimeReader estimates the regime activity value w(t_{c}), and updates the regime shift matrix R in Θ based on Expression 3 (i.e., min∥X_{c}−f_{c}(Θ)∥). Subsequently, RegimeReader calculates the estimated event V_{E}=f_{E}(Θ) as the optimal value for the current window X_{c}. Here, as a method for minimizing the mean square error ∥•∥, the LM (Levenberg-Marquardt) algorithm is employed, which is suitable as a learning algorithm for handling non-linear data.

Next, description will be made with reference to FIG. 3B regarding RegimeEstimator, which is an algorithm for estimating a new regime. The target in this stage is to provide a method in a case in which an unknown regime is included in the current window X_{c}. In order to represent such an unknown time-series pattern included in the current window X_{c}, an algorithm is proposed. The proposed algorithm estimates a new regime θ, and inserts the new regime θ thus estimated into the parameter set Θ.

Here, the regime represented by θ is composed of a very large number of parameters, which is a significant problem. Typically, it is very difficult for such a learning algorithm to simultaneously estimate an optimal solution for such a large number of parameters represented by a non-linear model, leading to increased calculation costs. Furthermore, it is important for the non-linear activity tensor A to be sparse in order to eliminate the complexity of the dynamical system.

In order to solve this problem, RegimeEstimator is proposed as an algorithm for high-speed and effective estimation of a parameter set regardless of whether the parameter set to be estimated is represented by a linear model or a non-linear model. Specifically, the parameter set θ is split into two kinds of partial sets, i.e., a linear parameter set θ_{L}={p, Q, u, V}, and a non-linear parameter set θ_{N}={A}, which are separately estimated. Referring to FIG. 3B, upon receiving the current window X_{c}, the proposed algorithm sets the non-linear activity tensor A to 0, and estimates the initial state so and the linear parameter set θ_{L} to be used to represent the linear pattern of the current window X_{c}. The parameters are estimated using the EM (expectation-maximization) algorithm. Subsequently, the non-linear elements A are estimated using the initial state so and the linear parameter set θ_{L} thus estimated such that the error value between the current window X_{c} and the latent value V_{C} is minimized using the LM algorithm. In this research, in the estimation of the non-linear tensor A, only the diagonal components aᵢⱼₖ∈A(i=k=k) are estimated in order to eliminate the complexity of the model.

Description has been made above regarding a generating method for generating the estimated event V_{E} for a single-level regime set Θ. The goal of the present research is to represent a multi-level time-series pattern M={Θ⁽¹⁾, . . . , Θ^{(h)}}, and to estimate the lₛ-step-ahead forecast window V_{F}. That is to say, when an event stream X is supplied, there is a demand to represent various levels of dynamical patterns such as yearly, monthly, and daily patterns, etc. In order to meet such a demand, the present invention proposes a forecasting method based on a multi-level model. Specifically, the current window X_{c} is decomposed into a multi-level event set X_{c}=X_{C}⁽¹⁾+ . . . +X_{C}^{(h)} so as to provide more effective forecasting. Here, “X_{C}⁽ⁱ⁾)” represents the i-th level event, which is calculated based on Expression 4. The function g(•|t) represents the moving average of the length t. In this specification, H={2 •lₛ, 1} is employed.

$${X}_{C}^{( i )} = g ( {X}_{C} {\sum }_{j = 1}^{i} {X}_{C}^{( i )} \vert H ( i ) ) \qquad [ Expression 4 ]$$

FIG. 3C shows a detailed algorithm of RegimeCast. Upon receiving a new event x(t_{c}) at the time tick t_{c}, with the present invention, RegimeCast calculates the current window X_{C}⁽ⁱ⁾ for each level i, and (1) estimates the event sequence V_{E}⁽ⁱ⁾. If there is no appropriate regime in Θ⁽ⁱ⁾, (i.e., when the difference between the current window and the estimated event is equal to or larger than ε=½∥X_{C}⁽ⁱ⁾∥, for example), RegimeCast (2) generates a new regime θ, and updates the regime parameter set Θ⁽ⁱ⁾. Finally, RegimeCast (3) outputs the lₛ-step-ahead forecast window V_{F}.

Next, description will be made regarding a high-speed operation based on the dynamic point set (DSP). As shown in the model represented by Expression 3, RegimeReader operates based on a complex dynamical system. Accordingly, RegimeReader requires the amount of calculation O(lₑ) to estimate the potential value S_{E}={s(tₘ), . . . , s(tₑ)}. Here, “lₑ” represents the length of S_{E}. However, the calculation time can become a bottleneck for real-time processing. In order to solve such a problem, the present invention proposes a technique for providing high-speed dynamical event generation. Specifically, instead of generating all the event set S_{E}={s(tₘ), s(tₘ₊₁), s(tₘ₊₂), . . . , s(tₑ)}, only a partial set of the vent set S_{E}, represented by S\hat{ }_{E}={s(tₘ), s(tₘ+δ), s(tₘ+2δ), . . . , s(tₑ)}, is generated. The partial set S\hat{ }_{E} will be referred to as the “DSP”. Here “δ” represents a time interval for which each potential value is generated (δ=0.1 •lₛ, for example). The partial set S\hat{ }_{E} is generated based on the fourth-order Runge-Kutta method represented by Expression 5. This reduces the model estimation calculation time to the length of S\hat{ }_{E} represented by O(lₑ/δ), thereby providing a dramatically improved high-speed operation.

Description will be made regarding theoretical analysis results with the length of the estimated event set V_{E} as lₑ, and with the number of regimes included in M as c. In this example, the calculation time of RegimeCast for each time tick is represented by a minimum of O(c•lₑ/δ), and by a maximum of O(c •lₑ/δ+l_{c}). RegimeReader requires the calculation time represented by O(c •lₑ/δ) to estimate c multiple optimal regimes V_{E}. In a case in which the current window X_{c} includes a new regime, RegimeEstimator requires the calculation time O(l_{c}) to estimate the parameter set θ. Thus, RegimeCast requires the calculation time represented by a minimum of O(c •lₑ/δ), and by a maximum of O(c •lₑ/δ+l_{c}).

$$( t + δ ) = ( t ) + \frac{1}{6} ( {K}_{1} + 2 {K}_{2} + 2 {K}_{3} + {K}_{4} ) + O ( {δ}^{5} ) \\ \frac{d ( t )}{dt} = F ( ( t ) ) , {K}_{1} = δ F ( ( t ) ) , {K}_{2} = δ F ( ( t ) + \frac{1}{2} {K}_{1} ) , \\ {K}_{3} = δ F ( ( t ) + \frac{1}{2} {K}_{2} ) , {K}_{1} = δ F ( ( t ) + {K}_{3} ) , \qquad [ Expression 5 ]$$

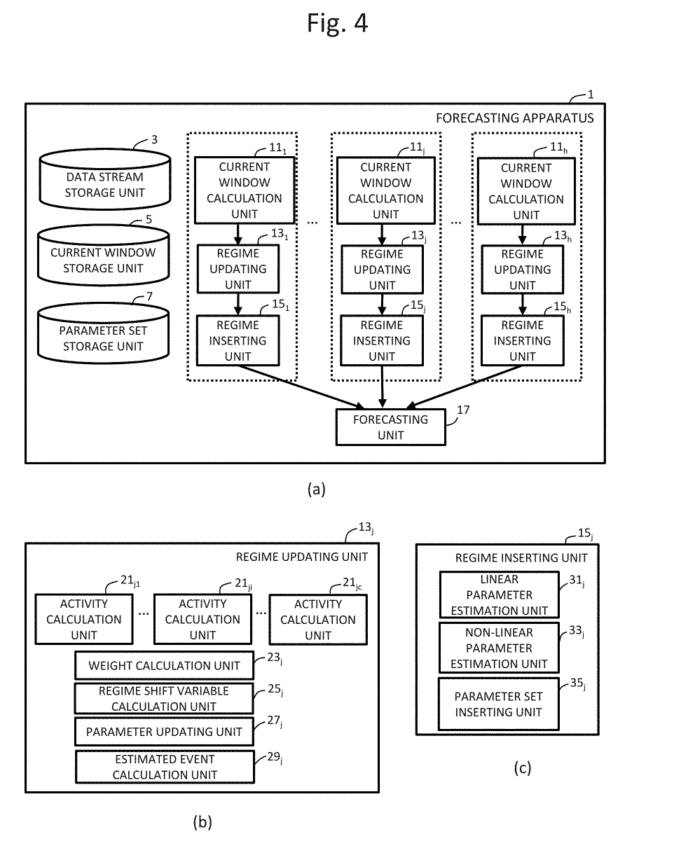

Description will be made with reference to FIGS. 4, 5, and 6 regarding an example of the configuration and the operation of a forecasting apparatus according to an embodiment of the present invention.

FIG. 4 is a block diagram showing a schematic configuration of a forecasting apparatus 1 according to an embodiment of the present invention. FIG. 4A shows the configuration of the forecasting apparatus 1. FIGS. 4B and 4C show a regime updating unit 13ⱼ and a regime inserting unit 15ⱼ, respectively.

Referring to FIG. 4A, the forecasting apparatus 1 includes a data stream storage unit 3, a current window storage unit 5, a parameter set storage unit 7 (which corresponds to an example of the “parameter set storage unit” in the appended claims), h (h represents an integer) current window calculation units 11ⱼ (j=1, . . . , h), h regime updating units 13ⱼ (which correspond to an example of the “regime updating unit” in the appended claims), regime inserting units 15ⱼ (which correspond to an example of the “regime inserting unit” in the appended claims), and a forecasting unit 17 (which corresponds to an example of the “forecasting unit” in the appended claims). It should be noted that, in some cases, the appended suffixes will be omitted. The data stream storage unit 3, the current window storage unit 5, and the parameter set storage unit 7 can be configured as a storage device such as memory, a hard disk, or the like, for example. Also, the current window calculation unit 11, the regime updating unit 13, the regime inserting unit 15, and the forecasting unit 17 can each be configured as a calculation device such as a CPU or the like.

Referring to FIG. 4B, the regime updating unit 13ⱼ includes c (c represents an integer) activity calculation units 21ⱼᵢ, a weight calculation unit 23ⱼ, a regime shift variable calculation unit 25ⱼ, a parameter updating unit 27ⱼ, and an estimated event calculation unit 29ⱼ.

Referring to FIG. 4C, the regime inserting unit 15ⱼ includes a linear parameter estimation unit 31ⱼ, a non-linear parameter estimation unit 33ⱼ, and a parameter set inserting unit 35ⱼ.

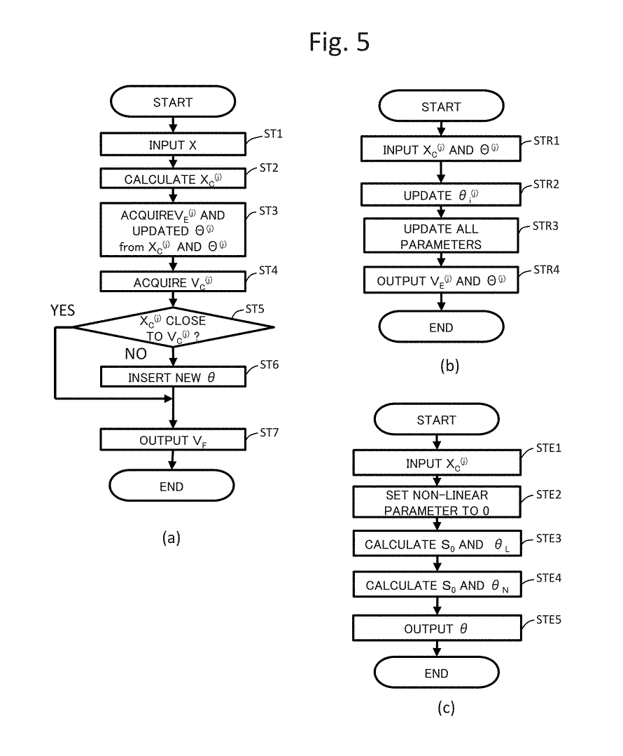

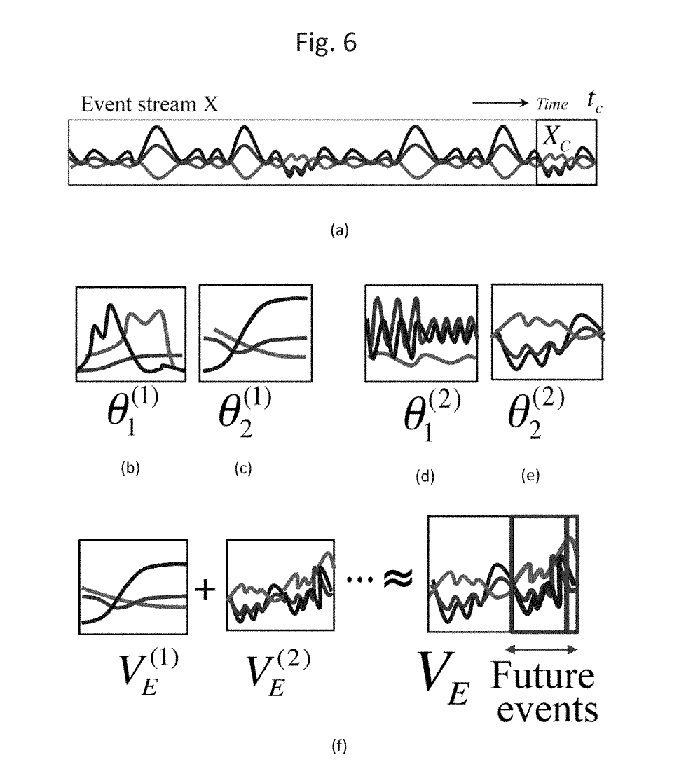

FIGS. 5A through 5C are diagrams showing an example of the operation of the forecasting apparatus 1 shown in FIG. 4A, an example of the operation of the regime updating unit 13ⱼ shown in FIG. 4B, and an example of the operation of the regime inserting unit 15ⱼ shown in FIG. 4C, respectively. The operations shown in FIGS. 5A, 5B, and 5C are substantially the same as those shown in FIGS. 3C, 3A, and 3B, respectively. FIG. 6 shows an example of the data generated by the forecasting apparatus 1 shown in FIG. 4.

Description will be made with reference to FIG. 5A regarding the operation of the forecasting apparatus 1. A time-series data stream X is input to the forecasting apparatus 1 (Step ST1). FIG. 6A shows an example of the data stream X. The data stream storage unit 3 stores the data stream X thus input.

The actual time-series data stream has a multi-level structure. The current window calculation unit 11ⱼ, the regime updating unit 13ⱼ, and the regime inserting unit 15ⱼ each handle the corresponding h-level time-series data stream in order to perform analysis using a multi-level structure.

The current window calculation unit 11ⱼ generates the current window X_{C}^{(j)} of the corresponding level (Step ST2). FIG. 6A shows an example of the settings of the current window. The current window storage unit 5 stores the current window X_{C}^{(j)} thus generated.

The parameter set storage unit 7 stores the full parameter set M.

The regime updating unit 13ᵢ acquires V_{E}^{(j)} and the updated Θ^{(j)} from the current window X_{C}^{(j)} and the regime parameter set Θ^{(j)} (Step ST3). Detailed description will be made later regarding a specific operation with reference to FIG. 5B. FIGS. 6B and 6C show the data generated based on two parameter sets θ₁(1) and θ₂(1) each set for the first level, respectively. FIGS. 6D and 6E show the data generated based on two parameter sets θ₁(2) and θ₂(2), respectively. It should be noted that, in actuality, a large number of parameter sets are employed.

The regime inserting unit 15ᵢ acquires V_{C}^{(j)} which corresponds to the current window X_{c}^{(j)} for each time tick using the updated Θ^{(j)} (Step ST4). Subsequently, judgment is made whether or not the difference between the current window X_{c}^{(j)} and the event value V_{C}^{(j)} is sufficiently small (Step ST5). As shown in FIG. 3, the error judgement may be made by making judgment regarding whether or not the mean square error is equal to or smaller than a predetermined value ε, for example. When these values are close to each other and the inserting condition is not satisfied, the flow proceeds to Step ST7. Conversely, when these values are not close to each other, and the inserting condition is satisfied, the regime inserting unit 15ⱼ inserts a new parameter set θ (Step ST6), and the flow proceeds to Step ST7. Specific description will be made with reference to FIG. 5C regarding the processing performed in Step ST6.

In Step ST7, the forecasting apparatus integrates the estimated values V_{E}^{(j)} for the respective levels, so as to acquire the overall estimated value V_{E}. Subsequently, the forecasting apparatus outputs the lₛ-step-ahead future event value V_{F}. FIG. 6F shows the relation between the overall estimated value V_{E} thus obtained by integrating the respective estimated values V_{E}^{(j)} and the future event V_{F}.

Next, specific description will be made with reference to FIG. 5B regarding the operation of the regime updating unit 13ⱼ. In FIG. 4B, the number of the activity calculation units 21ⱼᵢ is the same as that of the parameter sets θ of the levels.

The regime updating unit 13ⱼ receives the input of the current window X_{c}^{(j)} and the regime parameter Θ^{(j)} at the current time tick (Step STR1). Subsequently, each activity calculation unit 21ⱼᵢ changes a part of the corresponding parameter set θᵢ^{(j)} so as to reduce the difference between the current window X_{c}^{(j)} and the event value V_{c}^{(j)} (Step STR2). Here, as the parameter to be changed, a parameter that differs from a non-linear parameter is employed, for example, as with the initial value.

Subsequently, the regime activity is analyzed. The weight calculation unit 25ⱼ determines the weight to be set for each event value V_{ci} such that the difference between the weighted V_{ci} and the current window X_{c} becomes smaller. The regime shift variable calculation unit 25ⱼ calculates the weighted difference for each V_{ci} so as to calculate the regime shift variable. The parameter updating unit 27ⱼ updates the regime parameter set Θ^{(j)} of the corresponding level using the regime shift variable (Step STR3). The estimated event calculation unit 29ⱼ calculates the estimated event V_{E}^{(j)} for each level, and outputs V_{E}^{(j)} and Θ^{(j)} (Step STR4).

Next, specific description will be made with reference to FIG. 5C regarding the operation of the regime inserting unit 15ⱼ. The regime inserting unit 15ⱼ receives the input of the current window X_{c}^{(j)} (Step STE1). Subsequently, the linear parameter estimation unit 31ⱼ initializes the non-linear parameter (Step STE2), and calculates an initial value and a linear parameter (Step STE3). Subsequently, the non-linear parameter estimation unit 33ⱼ calculates a new initial value and a non-linear parameter using the linear parameter thus calculated (Step STE4). The parameter set inserting unit 35ⱼ generates a parameter set using the parameter thus calculated, and inserts the new parameter set thus generated (Step STE5).

With the present invention, upon receiving a large-scale data stream, this arrangement is configured to capture important trends, and to model various kinds of time-evolving patterns (regimes), thereby providing long-term forecasting. The important features of the present invention can be represented as follows. That is to say, with the present invention, the concept of regime shift in the natural ecosystem model is extended, and such a large-scale time-series data stream is represented as an adaptive non-linear dynamical system. This arrangement allows a complex time-series pattern to be represented in a flexible manner, thereby allowing long-term event forecasting.

(1) Latent Non-Linear Dynamical Pattern

As with natural dynamical systems, actual data streams in the real world evolve over time, depending on various kinds of latent factors. For example, a vehicle sensor data stream evolves with time depending on various kinds of factors such as traffic conditions, weather conditions, driver conditions, etc. Also, Web access history data evolves depending on user preferences and interests. Accordingly, with the present invention, latent patterns of a time-series data stream are represented as a non-linear dynamical system. More specifically, the time-series data sequence is represented by a latent non-linear differential equation.

(2) Regime Shift in Data Streams

Furthermore, with the present invention, this arrangement automatically captures an important transition point (regime shift in a data stream) in a time-series pattern. With the present invention, a time-series data stream is modeled based on the regime shift concept. By employing multiple non-linear models, this arrangement allows all the time-series patterns to be represented even if they have complex variations.

(3) Nested Multi-Level Structure

In actuality, a time-series data stream is configured as a nested multi-level dynamical system based on different time evolution. That is to say, a time-series data stream has a multi-level structure. With the present invention, a model based on such a multi-level structure is employed, thereby providing high-precision forecasting.

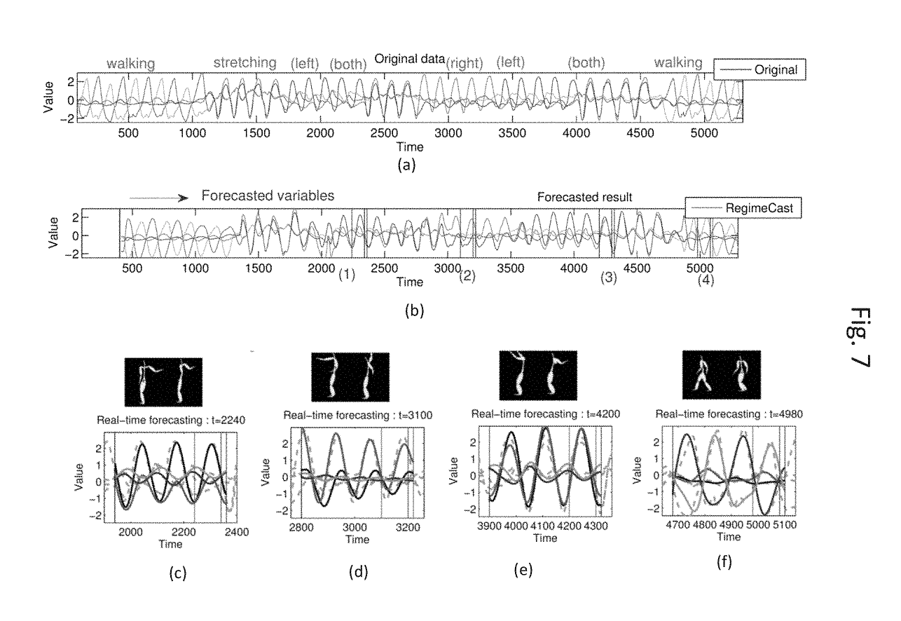

Description will be made with reference FIGS. 7 through 11 regarding experimental forecasting results.

FIG. 7 shows an example of RegimeCast analysis results for a motion stream of physical exercise. The data set is generated based on left and right arm motions and left and right leg motions, and is composed of multiple motion patterns such as a walking pattern, stretching pattern, etc. FIG. 7A shows the original data. FIG. 7B shows (100:120)-steps-ahead future events for every lₚ=20 time ticks. FIGS. 7C through 7F show snapshots at four different time ticks. The following positive results were successfully obtained. That is to say, RegimeCast is capable of automatically and effectively detecting multiple regime shifts such as a shift from the stretch motion to the walking motion, and of continuously forecasting future events over a long period.

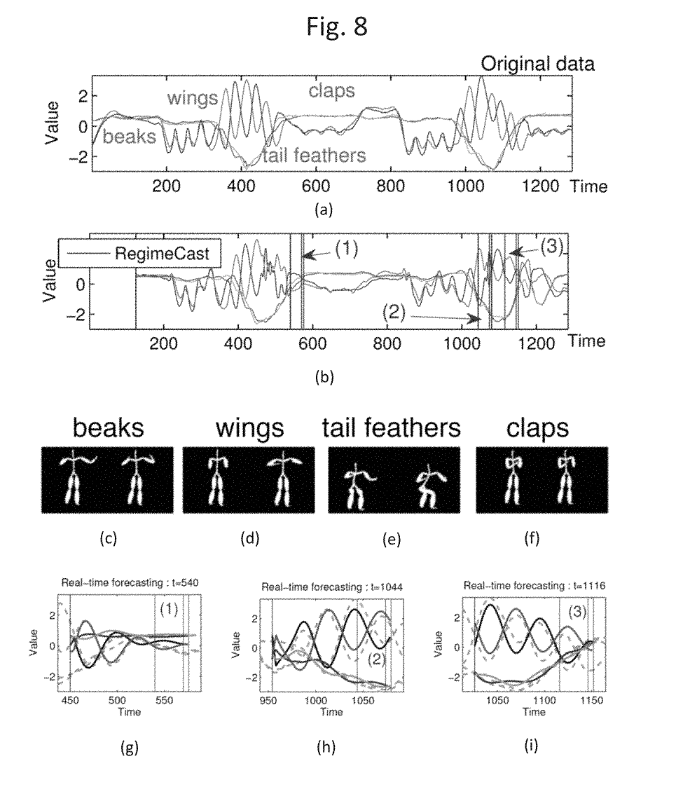

FIG. 8 shows an example of the analysis result of RegimeCast for a chicken-dance stream. Specifically, FIG. 8A shows the original data. FIG. 8B shows the analysis result, which is composed of four typical dance steps, i.e., “beaks”, “wings”, “tail feathers”, and “claps”. Typically, such a dance step pattern contains multi-level regimes, and is composed of more complex time-series patterns. Accordingly, it is very difficult to forecast such a dance step pattern. Specifically, as shown in FIGS. 6C through 6F, each step contains several basic motions, each of which has a different tempo. RegimeCast is capable of representing a complex time-series pattern composed of multiple latent regimes, thereby successfully forecasting such motions over a long period of time. In particular, RegimeCast requires no previous knowledge and no information for each step. RegimeCast captures an important time-series pattern (regime) with high speed, and stores the new regime thus captured in a time-series model database, thereby providing continuous and flexible event forecasting.

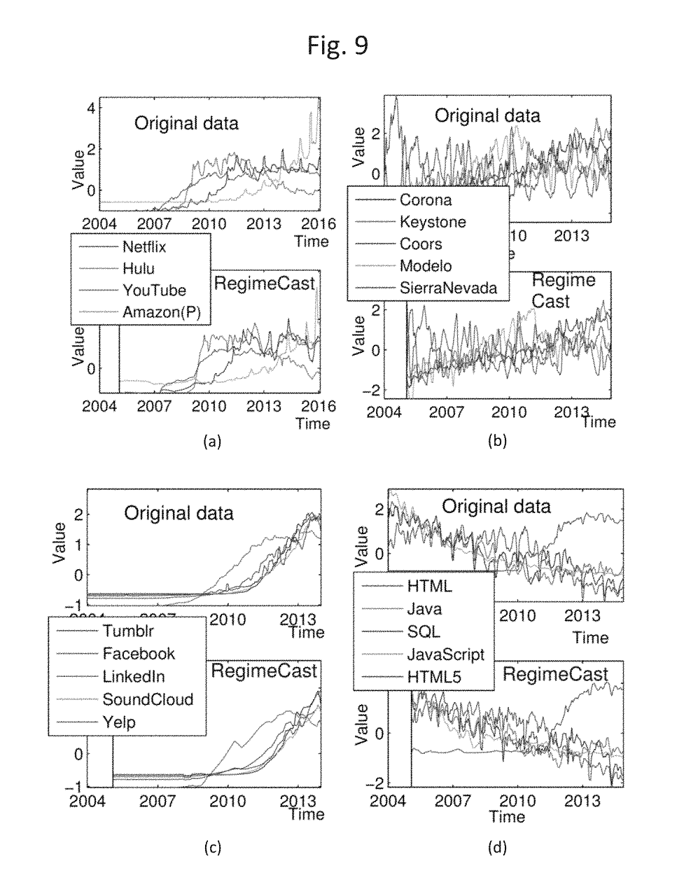

The present invention is applicable to Web information in addition to such motion capture data. FIG. 9 shows the forecasting results for a three-month-ahead future search volume for each keyword in Google. As can be understood from FIG. 9, this arrangement allows the user to forecast three-month-ahead future hot topic information. In addition, the present invention also exhibits high forecasting performance for environmental information (atmospheric temperature, atmospheric pressure) and economic information (exchange rates, gold market prices, platinum market prices).

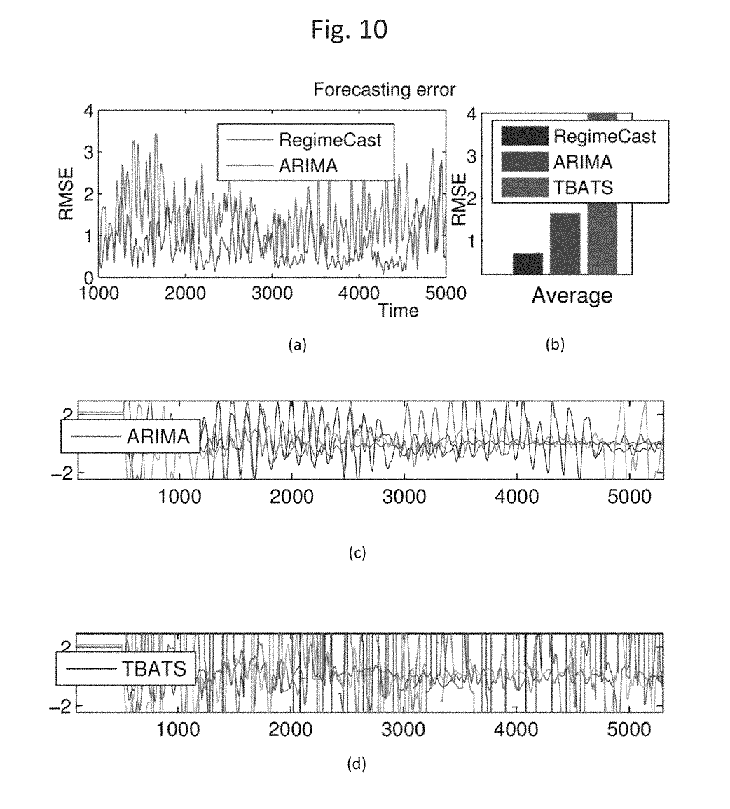

FIG. 10 shows a forecasting result comparison between the present invention and conventional techniques. As the conventional techniques to be compared, ARIMA and TBATS were employed. FIGS. 10A and 10B each show the error values calculated as the root mean square error (RMSE) values between the original data and the (100; 120)-steps-ahead forecasted events, and the average values thereof, respectively. The TBATS method involves very large error values. Accordingly, the forecasting results obtained by the TBATS method are not shown in FIG. 10A. FIGS. 10C and 10D show the forecasting results provided by the ARIMA method and the TBATS method, respectively. The ARIMA method and the TBATS method are conventional forecasting methods, and are not capable of representing a non-linear time-series pattern and a regime shift that occurs in such a non-linear time-series pattern. Thus, it can be understood that such an arrangement is not capable of providing appropriate forecasting.

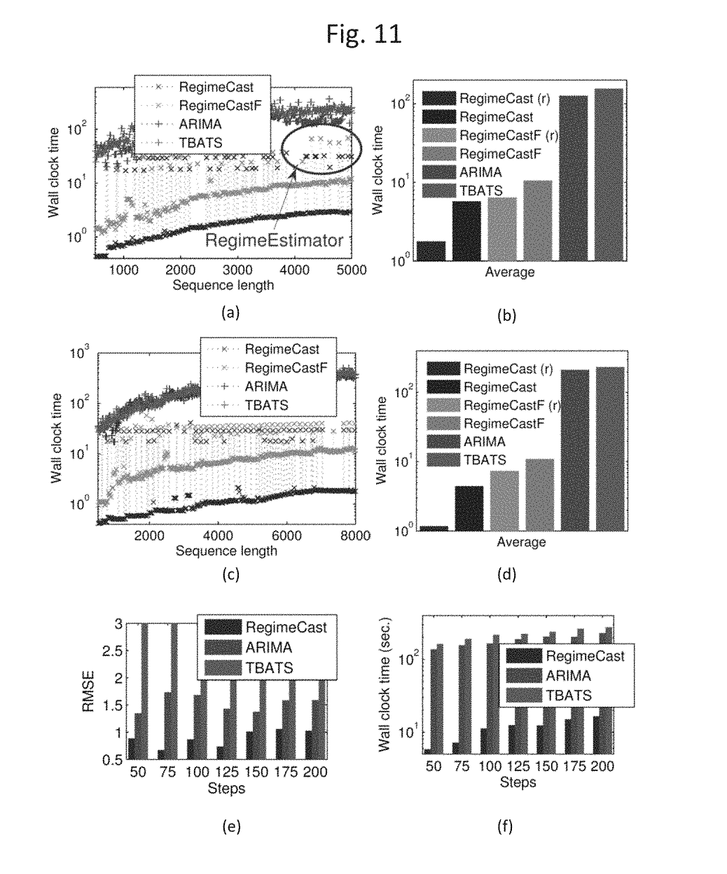

FIG. 11 shows the calculation costs required for the proposed method and conventional methods, and shows the forecasting accuracy and the calculation costs for long-term event forecasting. It should be noted that, in order to evaluate the DPS effects, a comparison was performed for a case in which the time interval is set to δ=1 (RegimeCast-F). FIGS. 11A and 11B show the calculation costs required to forecast an exercise stream and the averages thereof, respectively. FIGS. 11C and 11D show the calculation costs required to forecast a housecleaning stream and the averages thereof, respectively. FIGS. 11E and 11F show the forecasting accuracy with the number of steps is as a variable which is set to 50, 75, . . . , 200. In all the cases, the proposed method exhibits dramatically improved event forecasting performance over a long period of time.

As shown in FIGS. 10 and 11, the proposed method has advantages for both forecasting accuracy and calculation costs.

### REFERENCE SIGNS LIST

1 forecasting apparatus, 3 data stream storage unit, 5 current window storage unit, 7 parameter set storage unit, 11 current window calculation unit, 13 regime updating unit, 15 regime inserting unit, 17 forecasting unit, 21 activity calculation unit, 23 weight calculation unit, 25 regime shift variable calculation unit, 27 parameter updating unit, 29 estimated event calculation unit, 31 linear parameter estimation unit, 33 non-linear parameter estimation unit, 35 parameter set inserting unit.

1. A forecasting apparatus configured to forecast one or a plurality of lₛ-step-ahead or greater event values from a time tick t_{c} using a current window X_{c} which is a part of a time-series data X acquired up to the time tick t_{c}, the forecasting apparatus comprising:
a parameter set storage unit;
a regime updating unit; and
a forecasting unit,
wherein the parameter set storage unit stores a parameter set that identifies a mathematical model,
wherein the mathematical model includes a non-linear component,
wherein the parameter set includes a non-linear parameter that identifies a coefficient of the non-linear component,
wherein the regime updating unit updates a part or otherwise all of the parameters included in the parameter set except for the non-linear parameter so as to reduce a difference between data of the current window X_{c} at each time tick and an event value V_{C} that corresponds to the current window X_{c} at the corresponding time tick obtained by calculation using a mathematical model identified by the updated parameter set,
and wherein the forecasting unit forecasts one or a plurality of lₛ-step-ahead or greater event values from the time tick t_{c} using the mathematical model identified by the updated parameter set.

2. The forecasting apparatus according to claim 1, wherein the parameter set storage unit stores c (c represents an integer) parameter sets θᵢ (i=1, . . . , c),
and wherein the forecasting unit forecasts an event value V_{E} using a part of or otherwise all of the updated c parameter sets θᵢ.

3. The forecasting apparatus according to claim 2, further comprising a regime inserting unit,
wherein the regime inserting unit is configured such that, when the difference between the data of the current window X_{c} at each time tick and the event value V_{C} at the corresponding time tick obtained using the updated c parameter sets θᵢ satisfies an inserting condition, the regime inserting unit inserts a new parameter set θ_{c+1} in the parameter set storage unit,
wherein the regime updating unit updates a part of or otherwise all of the parameters included in the (c+1) parameter sets θᵢ (i=1, . . . , c+1) except for the non-linear parameter,
and wherein the forecasting unit forecasts an event value using a part of or otherwise all of the mathematical models identified by the updated (c+1) parameter sets θᵢ (i=1, . . . , c+1).

4. The forecasting apparatus according to claim 1, wherein the mathematical model includes a linear component,
wherein the parameter set includes a linear parameter that identifies the linear component,
wherein the regime inserting unit determines the linear parameter without changing the non-linear parameter,
and wherein the regime inserting unit determines the non-linear parameter using the linear parameter thus determined.

5. The forecasting apparatus according to claim 1, wherein the current window X_{C}^{(j)} (j=1, . . . , h, h represents an integer) is configured to have a nested h-level structure,
wherein the parameter set is configured to have a nested h-level structure corresponding to the current window X_{C}^{(j)} having the nested h-level structure,
wherein the regime updating unit updates the parameter set for each level,
and wherein the forecasting unit forecasts an overall event value based on the event values forecasted for respective levels.

6. A parameter set generating method for generating a new parameter set by changing a part of a parameter set that identifies a mathematical model using a current window X_{c} which is a part of time-series data acquired up to a time tick t_{c}, wherein the mathematical model includes a non-linear component,
wherein the parameter set includes a non-linear parameter that identifies the non-linear component,
wherein the parameter set generating method comprises updating in which a regime updating unit included in an information processing apparatus updates a part of or otherwise all of parameters included in the parameter set without changing the non-linear parameter so as to reduce a difference between data of the current window X_{c} at each time tick and an event value V_{C} that corresponds to the current window X_{c} at the corresponding time tick calculated based on a mathematical model identified by the parameter set thus updated.

7. A program configured to instruct a computer to function as the forecasting apparatus according to claim 1.
